(19) United States
(12) Patent Application Publication
(10) Pub. No.: US 2014/0210925 A1
(43) Pub. Date: Jul. 31, 2014

(54) TERMINAL UNIT

(71) Applicants: Tsutomu Kojitani, Fukuoka (JP); Nobuyuki Gotou, Fukuoka (JP); Shigeru Narakino, Fukuoka (JP); Naoki Yamamoto, Fukuoka (JP); Shunjiro Takemori, Fukuoka (JP)

(72) Inventors: Tsutomu Kojitani, Fukuoka (JP); Nobuyuki Gotou, Fukuoka (JP); Shigeru Narakino, Fukuoka (JP); Naoki Yamamoto, Fukuoka (JP); Shunjiro Takemori, Fukuoka (JP)

(73) Assignee: PANASONIC CORPORATION, Osaka (JP)

(21) Appl. No.: 14/238,783

(22) PCT Filed: Aug. 31, 2012
(86) PCT No.: PCT/JP2012/005516

§ 371 Date: Feb. 13, 2014

(30) Foreign Application Priority Data
Sep. 6, 2011 (JP) 2011-194159
Dec. 14, 2011 (JP) 2011-273113

(51) Int. Cl. B41J 29/02

(52) U.S. Cl. CPC B41J 29/02
USPC 347/108

(57) ABSTRACT

A terminal unit (201) includes: a casing (204) having a display surface with a display part (205) disposed thereon; a printer head (212) provided inside the casing (204) so as to face the display surface and adapted to print on recording paper pulled out of a recording paper roll (216); and a recording paper roll housing part (222) provided on the side opposite to the display surface across the printer head (212) so as to face the printer head (212). Due to this configuration, the terminal unit (201) can be made compact in the longitudinal direction.

### TECHNICAL FIELD

The present invention relates to a terminal unit with a printer, which is a terminal unit functioning as a printer.

### BACKGROUND ART

Conventionally, a terminal unit functioning as a printer (terminal unit with a printer) has been used in operations of restaurants, retail stores, delivery services, and the like. For example, a terminal unit with a printer installed at distribution centers of delivery services includes a transaction function, etc. to output results of reception processing and transaction processing of deliveries being printed on roll paper or the like (e.g., see Patent Literature 1). Such a conventional terminal unit is typically provided with a display part on the upper half of the casing's surface (front surface), and with a printer unit at the upper part of the display part (upper end of the casing). That is, in planar view, the display part and the printer unit are disposed side by side on the surface of the terminal unit (Patent Literature 1). Another terminal unit includes a movable roll paper cutter for easy replacement of roll paper (Patent Literature 2).

In the conventional terminal units, however, as the display part and the printer unit are disposed side by side on the surface of the terminal unit, it is necessary to secure a space at the upper part of the display part (upper end of the casing) for providing the printer unit, which makes it difficult to reduce the longitudinal size (size in the upper-lower direction) of the terminal unit. In addition, as the terminal unit is made more compact, the printer paper cutter is brought closer to the printer paper and interferes with replacement of paper. Due to these factors, it has been difficult to make the terminal unit compact, especially in the longitudinal direction.

### CITATION LIST

### Patent Literature

Patent Literature 1: Japanese Patent Laid-Open No. 2004-114640
Patent Literature 2: Japanese Patent Laid-Open No. 2010-64323

### SUMMARY OF INVENTION

### Technical Problem

The present invention has been made under the above circumstances. It is an object of the present invention to provide a terminal unit with a printer which can realize a compact size in the longitudinal direction of the terminal unit.

### Solution to Problem

One aspect of the present invention is a terminal unit. This terminal unit includes: a casing having a display surface with a display part disposed thereon; a printer head provided inside the casing so as to face the display surface and adapted to print on recording paper pulled out of a recording paper roll; and a recording paper roll housing part provided on the side opposite to the display surface across the printer head so as to face the printer head.

As will be described below, there are other aspects of the present invention. This disclosure of the invention is therefore intended to provide some of the aspects of the present invention and not to limit the scope of the invention described and claimed herein.

### BRIEF DESCRIPTION OF DRAWINGS

FIG. 1 is an outline perspective view of a terminal unit with a printer (with a paper cover closed) in a first embodiment of the present invention.

FIG. 2 is an outline perspective view of the terminal unit with a printer (with the paper cover opened) in the first embodiment of the present invention.

FIG. 3 is a partial side view of the terminal unit with a printer in the first embodiment of the present invention.

FIG. 4 is an outline perspective view of a casing and the paper cover of the terminal unit with a printer in the first embodiment of the present invention.

FIG. 5 is a perspective view of a terminal unit with a printer in a second embodiment of the present invention.

FIG. 6 is an exploded perspective view of the terminal unit with a printer in the second embodiment of the present invention.

FIG. 7 is a side view of the terminal unit with a printer (with a paper cover closed) in the second embodiment of the present invention.

FIG. 8 is a side view of the terminal unit with a printer (with the paper cover opened) in the second embodiment of the present invention.

FIG. 9 is a side view of the terminal unit with a printer (with a paper holder opened) in the second embodiment of the present invention.

FIG. 10 is an illustrative view of how the paper holder opens due to its own weight in the second embodiment of the present invention.

FIG. 11 is an illustrative view of a state where a small roll paper is mounted in the second embodiment of the present invention.

FIG. 12 is an illustrative view of a state where a large roll paper is mounted in the second embodiment of the present invention.

FIG. 13 is an illustrative view of a state where the paper cover is further opened from a maximum opening position in the second embodiment of the present invention.

### DESCRIPTION OF EMBODIMENTS

Hereinafter, the present invention will be described in detail. However, the following detailed description and the accompanying drawings do not limit the invention.

A terminal unit with a printer of the present invention includes: a casing with a display part and an operation part provided on a surface thereof; a paper cover attached to the casing such that the paper cover can be opened and closed for loading of a recording paper roll into the inside of the casing; a printer head provided inside the casing at a position corresponding to the display part and adapted to print on recording paper pulled out of the recording paper roll; a paper ejection port formed near the printer head and ejecting the recording paper from a side of the terminal unit; and a pair of first guiding parts provided on the paper cover, wherein the recording paper can pass between the first guiding parts.

Due to this configuration, the recording paper roll is loaded into the terminal unit in a state where the recording paper pulled out of the recording paper roll is supported by the first guiding parts. Thus, it is possible to make the terminal unit compact while allowing the recording paper roll to be reliably placed in its correct position.

In the terminal unit with a printer of the present invention, the pair of first guiding parts may be protrusions provided at an interval almost equal to a width of the recording paper. Due to this configuration, it is possible to more reliably place the recording paper roll in its correct position.

In the terminal unit with a printer of the present invention, the first guiding parts may constitute a part of the paper ejection port. Due to this configuration, the first guiding parts guiding the recording paper can function as a paper ejection port, so that the terminal unit can be made compact with a smaller number of components.

The terminal unit with a printer of the present invention may include: a paper sensor provided near the printer head to detect passage of the recording paper; and a second guiding part provided on the paper cover to support the recording paper, wherein the second guiding part may be disposed at such a position that the second guiding part faces the paper sensor when the paper cover is closed.

Due to this configuration, passage of the recording paper can be reliably detected by sandwiching the recording paper, which is pulled out of the recording paper roll, between the paper sensor and the second guiding part. In addition, since the second guiding part is disposed at such a position that the second guiding part faces the paper sensor when the paper cover is closed, opened and closed states of the paper cover can be detected by detecting presence and absence of the second guiding part. Thus, it is not necessary to provide a sensor for detecting opening and closing of the paper cover, so that the terminal unit can be made compact and lower in cost.

According to the present invention, it is possible, with a simple configuration, to make the terminal unit compact while allowing the recording paper roll to be reliably placed in its correct position.

The terminal unit with a printer of the present invention includes: a casing with a display part and an operation part provided on a surface thereof; a printer unit provided inside the casing at a position corresponding to the display part on the surface; a paper holder provided inside the casing near the printer unit to hold roll paper for printing; and a paper cover attached to the casing through cover hinges such that the paper cover can be opened and closed to allow mounting or dismounting of the roll paper.

Due to this configuration, the printer unit and the roll paper are disposed inside the casing at the positions corresponding to the display part on the surface (the same position as the display part in planar view). Thus, by disposing the printer unit (and the roll paper) at the positions corresponding to the display part (the same position in planar view), the longitudinal size (size in the upper-lower direction) of the terminal unit can be made smaller compared with the case where the printer unit is disposed at the upper part of the display part (upper end of the casing). In addition, this configuration makes it possible to easily mount or dismount the roll paper, without worrying about the cutter, by opening the paper cover of the printer unit.

In the terminal unit with a printer of the present invention, the paper holder may be coupled with the paper cover and opened together with the paper cover as the paper cover is opened.

Due to this configuration, since the paper holder is coupled with the paper cover, the paper holder is opened together with the paper cover as the paper cover is opened, and the roll paper held by the paper holder is also taken out toward the side to which the paper cover is opened. Thus, the roll paper can be easily dismounted.

In the terminal unit with a printer of the present invention, the paper holder may be coupled with the paper cover through holder hinges, and in a state where the paper holder is opened together with the paper cover, the paper holder may be opened around the holder hinges in a direction away from the paper cover.

Due to this configuration, in a state where the paper holder is opened together with the paper cover, the paper holder can be opened in the direction away from the paper cover. By opening the paper holder in the direction away from the paper cover, even a large roll paper can be easily mounted or dismounted.

In the terminal unit with a printer of the present invention, in a state where the paper holder is opened together with the paper cover, the position of the center of gravity of the paper holder may be offset on the paper holder side from the position of the holder hinges, and the paper holder may open in the direction away from the paper cover due to its own weight.

Due to this configuration, when the paper holder is opened together with the paper cover, the position of the center of gravity of the paper holder is offset on the paper holder side from the position of the holder hinges. Thus, for example, when the paper cover is opened in a state where the roll paper is not held by the paper holder, the paper holder is opened together with the paper cover, and then, the paper holder further opens due to its own weight (automatically) in the direction away from the paper cover. Therefore, there is no need to manually open the paper holder, which facilitates the mounting work of the roll paper.

In the terminal unit with a printer of the present invention, when the paper cover is further opened from a state of being opened to a maximum opening position, the cover hinges may be disengaged such that the paper cover and the paper holder are detached from the casing.

Due to this configuration, when the paper cover is further opened from the maximum opening position, the cover hinges are disengaged such that the paper cover and the paper holder are detached from the casing. Thus, it is possible to prevent a situation where an excessive load is applied to the cover hinges and the cover hinges and the surrounding areas are damaged.

In the terminal unit with a printer of the present invention, a window part for viewing the roll paper held by the paper holder may be provided on a side of the casing, and the holder hinges may be provided at positions where the holder hinges are invisible through the window part.

Due to this configuration, the roll paper held by the paper holder is visible through the window part on the side of the casing, and a remaining amount of the roll paper, etc. can be easily checked. In this case, since the holder hinges are disposed at the positions where the holder hinges are invisible through the window part, the appearance of the terminal unit can be prevented from being impaired due to the holder hinges being visible through the window part.

According to the present invention, the terminal unit can be made compact in the longitudinal direction, and moreover, the paper roll can be easily mounted and dismounted.

Hereinafter, the terminal unit with a printer according to the embodiments of the present invention will be described with reference to the drawings. These embodiments will be described by taking as an example a terminal unit with a printer which is used as a transaction terminal unit installed at distribution centers of delivery services. Although the embodiments will be described by taking a stationary-type unit as an example, the terminal unit with a printer may be a portable-type unit such as carried by delivery persons.

### First Embodiment

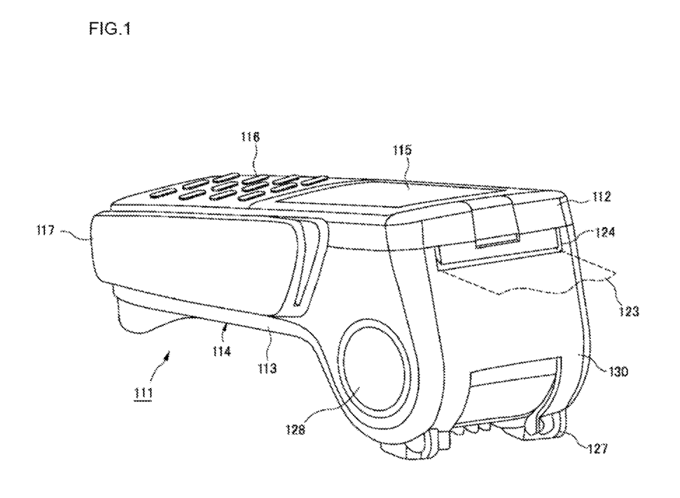

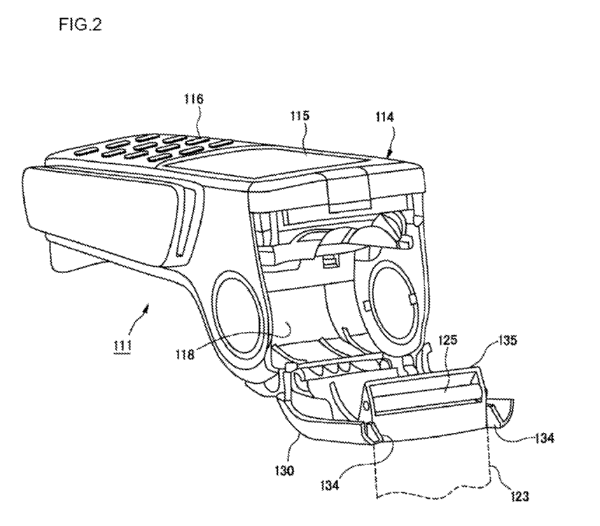

As shown in FIG. 1 and FIG. 2, a terminal unit with a printer 111 in a first embodiment includes a casing 114 constituted of an upper case 112 and a lower case 113. A display part 115 and an operation part 116 are provided on the upper half and on the lower half, respectively, of the surface (front surface) of the casing 114. The surface (upper surface) of the casing 114 can also be called a display surface with the display part 115 disposed thereon. The display part 115 is, for example, constituted of a liquid crystal panel, and the operation part 116 is, for example, constituted of input keys. A magnetic card reading device 117 for reading information on magnetic cards is provided on a side of the casing 114.

A portion of the lower case 113 facing the operation part 116 is parallel to the operation part 116, and the lower case 113 and a recording paper roll housing part 118, which is provided in a portion facing the display part 115, form a substantially P-shaped cross-section. This allows a user to operate the operation part 116 while holding it in the user's hand. The display part 115 may be constituted of a touch panel; in this case, the display part 115 and the operation part 116 may be formed integrally.

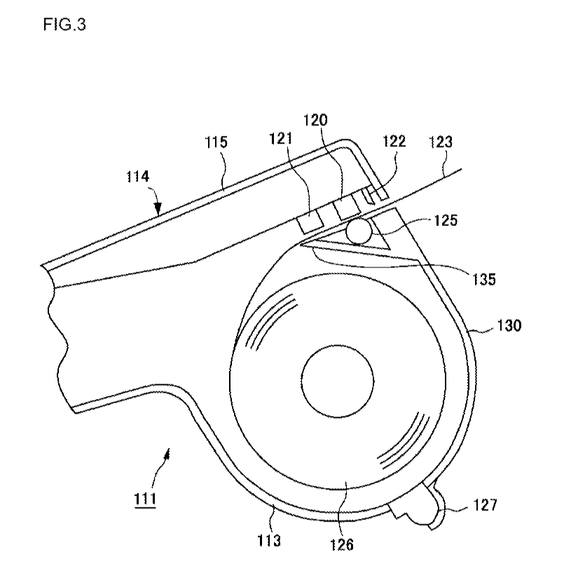

As shown in FIG. 3, a printer unit constituted of a printer head 120, a paper sensor 121, and a cutter 122 is provided inside the casing 114 at the lower side of the display part 115. The printer head 120 is provided inside the casing 114 so as to face the display surface (i.e., to be face-to-face with the display surface). In this case, when seen from the display surface of the casing 114, the printer head 120 and the recording paper roll housing part 118 are disposed eccentrically on the side of one end (one end in the longitudinal direction) of the casing 114 where the display part 115 is provided. The display surface of the casing 114, a surface of the printer head 120 facing the display surface of the casing 114, and an imaginary central axis of a recording paper roll 126 are parallel to one another. In addition, a paper ejection port 124 for ejecting a recorded piece of recording paper 123 to the outside of the terminal unit is formed on a side (side further from the operation part 116) of the casing 114. The cutter 122 is disposed inside the casing 114 between the printer head 120 and the paper ejection port 124 on the side of the display surface.

For example, a thermal head is used as the printer head 120, and the printer head 120 sandwiches a leading end portion of the recording paper 123, which is fed from the recording paper roll 126, between the printer head 120 and a platen roller 125 provided to face the printer head, and prints on the recording paper 123 under control of a driver (not shown).

The paper sensor 121 detects whether there is the recording paper 123 on a feeding path. When absence of the recording paper 123 is detected, the paper sensor determines that the terminal unit has run out of paper (or the paper is not correctly placed), and outputs a signal for outputting and displaying an error message on the display part 115.

The cutter 122 cuts the recording paper 123 by moving toward the recording paper 123 after the printer head 120 finishes printing on the recording paper 123. Alternatively, a movable member may be provided in a portion facing the cutter 122, and the recording paper 123 sandwiched between the cutter 122 and this movable member may be cut by moving the movable member toward the cutter 122.

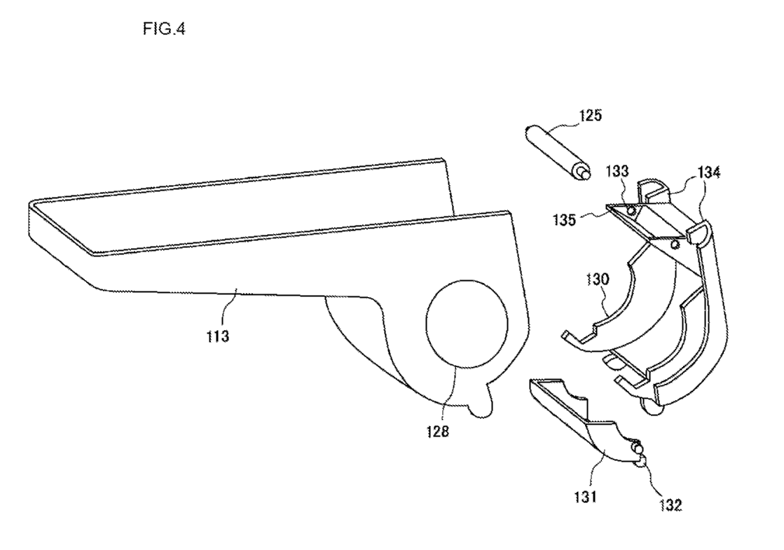

In FIG. 1, a paper cover 130 is attached to the lower case 113 of the casing 114 through cover hinges 127 such that the paper cover can be opened and closed. The cover hinges 127 are provided on the side opposite to the printer head 120 across the recording paper roll housing part 118. The paper cover 130 constitutes a part of the paper ejection port 124 at an end opposite to the cover hinges 127. As shown in FIG. 4, the paper cover 130 is provided with a paper holder 131 for holding the recording paper roll. The paper holder 131 is attached to a position near the paper cover 130 through holder hinges 132, and holds the recording paper roll 126 at the lower part of the display part 115. When the paper cover 130 is opened for replacement of the recording paper roll 126, the paper holder 131 is opened together with the paper cover 130, but the paper holder 131 is opened around the holder hinges 132 in the direction away from the paper cover 130. Thus, the recording paper roll 126 can be easily replaced with the paper cover 130 opened. In addition, the recording paper roll 126 can be replaced without bringing fingers closer to the cutter 122.

As shown in FIG. 1 and FIG. 2, a window part 128 for viewing from outside the recording paper roll 126 held by the paper holder 131 is provided on a side of the casing 114. The window part 128 is provided on a surface of the casing 114 which intersects both of a paper ejection surface, where the paper ejection port 124 is provided, and the display surface. In this case, the holder hinges 132 are preferably disposed at positions (around the window part) where the holder hinges are invisible through the window part 128 from the outside.

As shown in FIG. 4, the paper cover 130 is formed with support holes 133 for supporting the platen roller 125, and is provided with first guiding parts 134 and a second guiding part 135 which guide the feeding of the recording paper 123. The first guiding parts 134 constitute a part of the paper ejection port 124, and the recording paper 123 passes between the first guiding parts 134 before being ejected to the outside of the terminal unit.

The first guiding parts 134 are provided near the paper ejection port 124, and are a pair of protrusions provided at an interval almost equal to a width of the recording paper roll 126. The first guiding parts 134 are provided at an end opposite to the cover hinges 127 of the paper cover 130. The leading end portion of the recording paper 123 pulled out of the recording paper roll 126 passes between the first guiding parts 134 and is ejected to the outside of the casing 114 from the paper ejection port 124. As shown in FIG. 2, when placing the recording paper roll 126 into the terminal unit, a constant direction of the leading end portion of the recording paper 123 is maintained at all times by passing the leading end portion of the recording paper 123 between the first guiding parts 134. Thus, it is possible to prevent occurrence of shift in the set position of the recording paper roll 126.

The second guiding part 135 of the paper cover is formed at such a position that the second guiding part faces the paper sensor 121 when the paper cover 130 is closed. The second guiding part 135 is positioned at the end opposite to the cover hinges 127, on the side opposite to the paper sensor 121 across an ejection path of the recording paper 123, so as to be face-to-face with the paper sensor 121. By the paper sensor 121 detecting the recording paper 123 guided by the second guiding part 135, it can be detected that the paper cover 130 is closed and whether or not there is the recording paper. The leading end portion of the recording paper 123 is fed between the second guiding part 135 and the paper sensor 121. Thus, even when the diameter of the recording paper roll 126 has become smaller, the recording paper 123 can be reliably detected.

The working of the terminal unit with a printer configured as described above will now be described. In the terminal unit 111 in this embodiment, the recording paper roll 126 is placed into the recording paper roll housing part 118 with the paper cover 130 opened. In the state where the paper cover 130 is opened, the second guiding part 135 does not face the paper sensor 121, so that the paper sensor 121 cannot detect the second guiding part 135. Thus, the terminal unit 111 can recognize that the paper cover 130 is opened, hence a sensor for detecting opened and closed states of the paper cover 130 can be omitted.

The recording paper 123 is pulled out of the recording paper roll 126 and passed between the first guiding parts 134 on the paper cover 130. Since the interval between the first guiding parts 134 is almost equal to the width of the paper, it is possible to reliably place the recording paper roll 126 in its correct position without visually checking the set position of the recording paper roll 126, by closing the paper cover 130 with the leading end of the recording paper roll 126 aligned with the first guiding parts 134. For example, in the case of a stationary-type terminal unit with a printer, this is effective in that an operator is relieved of the bother of placing the paper roll while visually checking the rear side (side opposite to the operator) of the terminal unit.

As shown in FIG. 4, when the paper cover 130 is closed, the second guiding part 135 of the paper cover 130 is placed at a position where the second guiding part faces the paper sensor 121, and the leading end portion of the recording paper 123 passes through a region between the second guiding part and the paper sensor. Thus, the paper sensor 121 can reliably detect the recording paper 123.

When a printing instruction is issued by the operator through operation of the terminal unit with a printer 111, the platen roller 125 is driven to feed the recording paper 123 toward the paper ejection port 124 and the printer head 120 is driven to perform an action of printing predetermined letters, etc. on the recording paper 123. When the printing process is finished, the recording paper 123 is further pulled out by the platen roller 125, and the cutter 122 is activated to cut the paper into a predetermined size.

Although in this embodiment, the first and second guiding parts 134 and 135 are provided integrally with the paper cover 130, these parts may be separated. In this case, the first and second guiding parts 134 and 135 can be used by fitting them to the paper cover 130.

### Second Embodiment

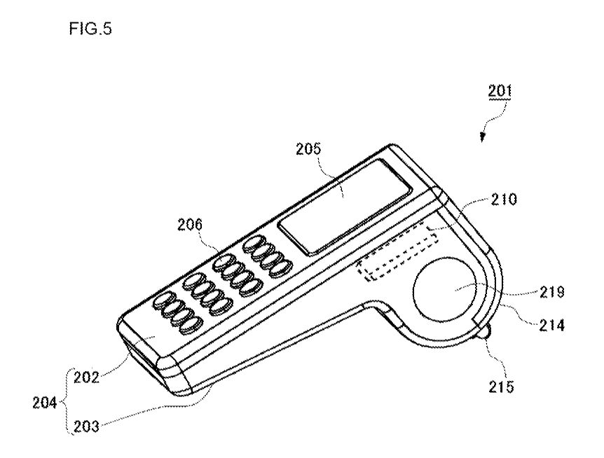

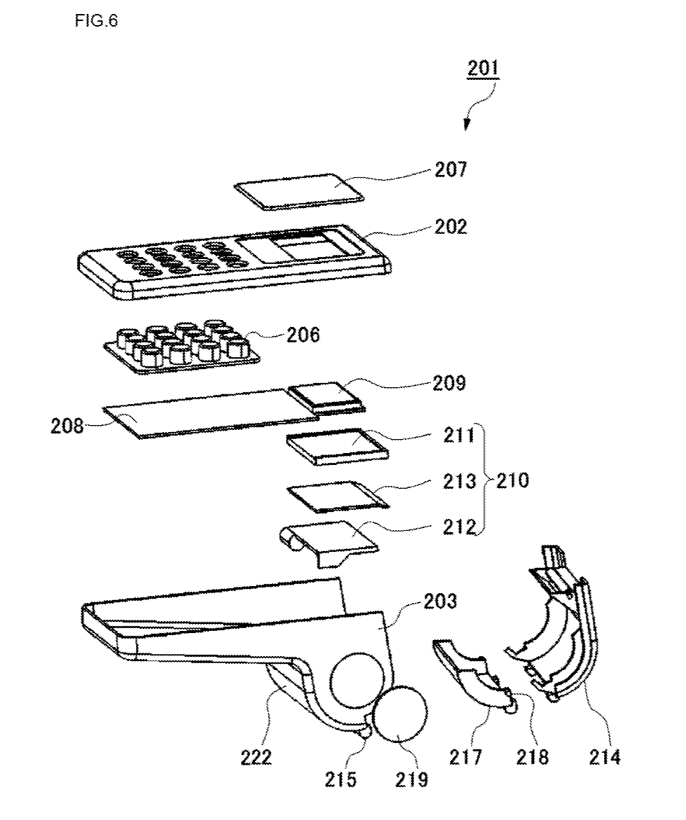

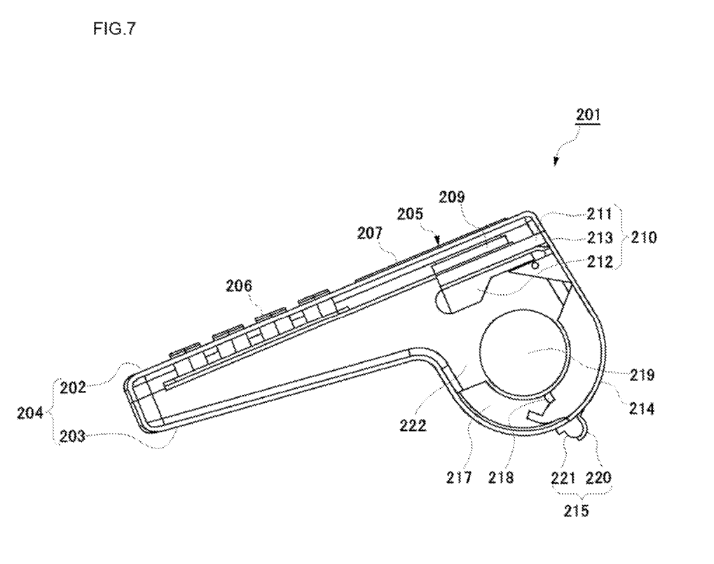

FIG. 5 is a perspective view of a terminal unit with a printer in a second embodiment, and FIG. 6 is an exploded perspective view of the terminal unit with a printer in the second embodiment. FIG. 7 to FIG. 9 are side views of the terminal unit with a printer in the second embodiment.

As shown in FIG. 5, a terminal unit with a printer 201 in this embodiment includes a casing 204 constituted of an upper case 202 and a lower case 203. A display part 205 and an operation part 206 are provided on the upper half and on the lower half, respectively, of the surface (front surface) of the casing 204. The surface (upper surface) of the casing 204 can also be called a display surface with the display part 205 disposed thereon. The display part 205 is constituted of a liquid crystal panel or the like, and the operation part 206 is constituted of input keys or the like. The lower case 203 corresponding to a back surface of the operation part 206 is almost parallel to the operation part 206. The lower case and a recording paper roll housing part 222, which is formed by a portion of the lower case 203 provided at the back of the display part 205 protruding downward, form a cross-section in the shape of the Roman letter P. Thus, the operation part 206 is easy to operate while holding it in one's hand. For example, as shown in FIG. 6, the display part 205 is, for example, constituted of a panel 207 attached to the surface of the casing 204 and a liquid crystal unit 209 connected to a printed circuit board 208 inside the casing 204. For example, the operation part 206 is constituted of rubber keys for input and a circuit for input (not shown) provided on the printed circuit board 208. The display part 205 may be constituted of a touch panel; in this case, the display part 205 and the operation part 206 may be formed integrally.

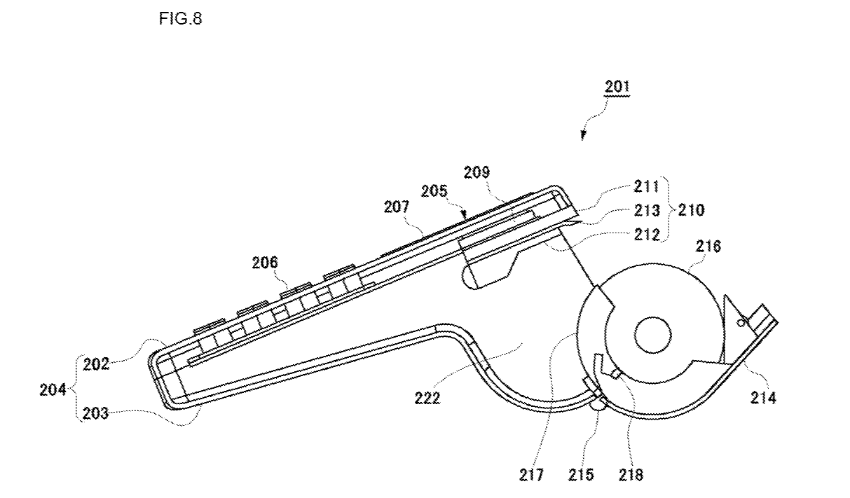

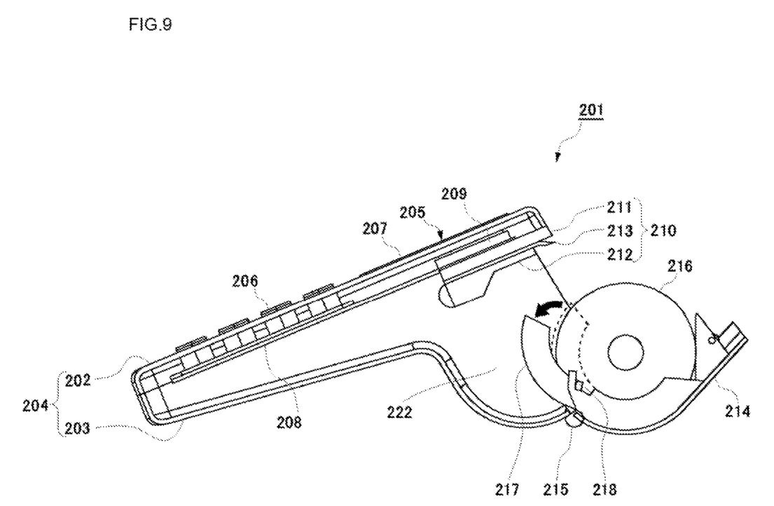

As shown in FIG. 6, a printer unit 210 is provided inside the casing 204 at a position corresponding to the display part 205 on the surface (the same position as the display part 205 in planar view). The printer unit 210 is, for example, constituted of a printer chassis 211, a printer head 212, and a cutter 213. The printer head 212 is provided inside the casing 204 so as to face the display surface (i.e., to be face-to-face with the display surface). In this case, when seen from the display surface of the casing 204, the printer head 212 and the recording paper roll housing part 222 are provided eccentrically on the side of one end (one end in the longitudinal direction) of the casing 204 where the display part 205 is provided. The display surface of the casing 204, the surface of the printer head 212 facing the display surface of the casing 204, and the imaginary central axis of the recording paper roll 216 housed in the recording paper roll housing part 222 (see FIG. 8, FIG. 9, etc. to be described later) are parallel to one another.

As shown in FIG. 7 to FIG. 9, the casing 204 is provided with a paper cover 214. The paper cover 214 is attached to the casing 204 through cover hinges 215 such that the paper cover 214 can be opened and closed. The cover hinges 215 are provided on the side opposite to the printer head 212 across the recording paper roll housing part 222. The paper cover 214 is provided with a paper holder 217 for holding the recording paper roll 216 for printing. The paper holder 217 is coupled with the paper cover 214 through holder hinges 218. The paper holder 217 is provided inside the casing 204 at a position near the printer unit 210, and can hold the recording paper roll 216 at a position corresponding to the display part 205 (the same position as the display part 205 in planar view).

As shown in FIG. 5 and FIG. 6, a window part 219 for viewing from the outside the recording paper roll 216 held by the paper holder 217 is provided on a side of the casing 204. The window part 219 is provided on a surface of the casing 204 which intersects both of a paper ejection surface, where the paper ejection port is provided, and the display surface. In this case, the holder hinges 218 are preferably provided at positions around the window part 219 where the holder hinges are invisible from the outside through the window part 219.

The working of the terminal unit with a printer 201 configured as described above will now be described with reference to the drawings.

In the terminal unit with a printer 201 of this embodiment, the paper cover 214 is opened to mount or dismount the recording paper roll 216 to or from the recording paper roll housing part 222. As shown in FIG. 8, the paper cover 214 can be opened by rotating it around the cover hinges 215. At this point, when the paper cover 214 is opened, the paper holder 217 is opened together with the paper cover 214. As shown in FIG. 9, the paper holder 217 can be opened around the holder hinges 218 in the direction away from the paper cover 214 (leftward in FIG. 9). Thus, the recording paper roll 216 can be mounted or dismounted with the paper cover 214 opened.

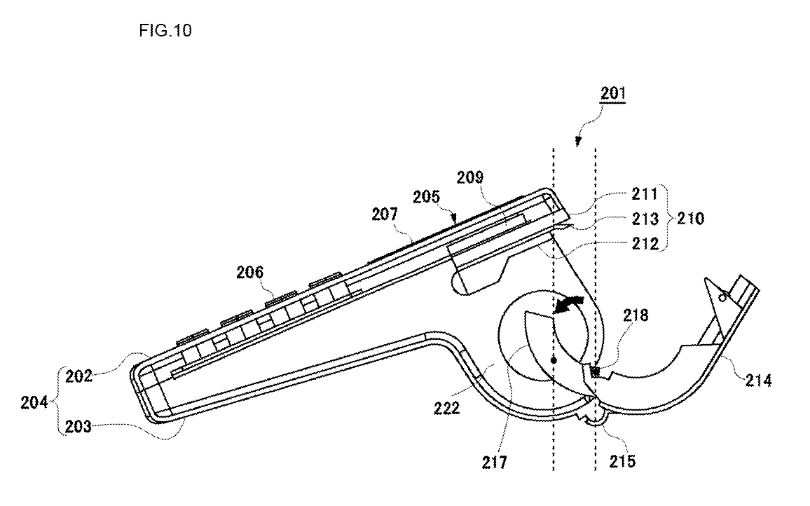

Now, an explanation will be given about the position of the center of gravity of the paper holder 217. As shown in FIG. 10, in a state where the paper holder 217 is opened together with the paper cover 214, the position of the center of gravity of the paper holder 217 is offset on the side of the paper holder 217 (left side in FIG. 10) from the position of the holder hinges 218. Thus, in a state where the recording paper roll 216 is not mounted, the paper holder 217 opened together with the paper cover 214 opens due to its own weight in the direction away from the paper cover 214 (leftward in FIG. 10).

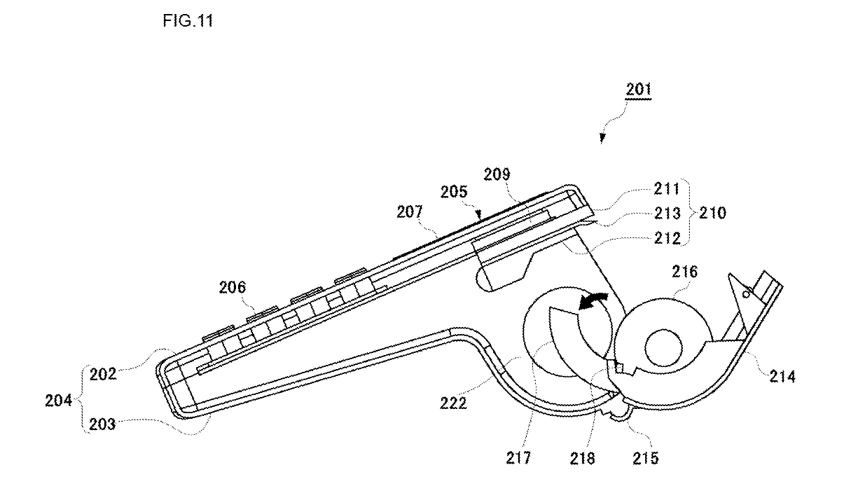

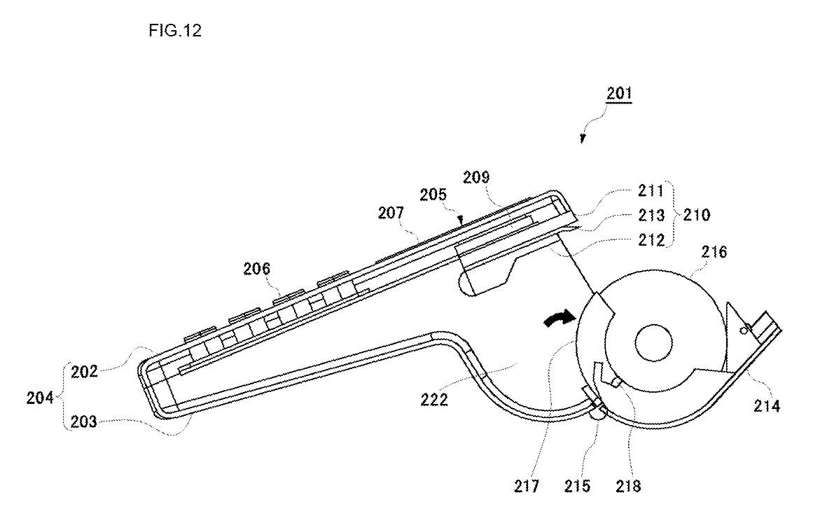

As shown in FIG. 11, even in a state where a small recording paper roll 216 is mounted, the paper holder 217 opened together with the paper cover 214 opens due to its own weight in the direction away from the paper cover 214 (leftward in FIG. 11). On the other hand, as shown in FIG. 12, when a large recording paper roll 216 is mounted, as the recording paper roll 216 lands on the lower part of the paper holder 217, the paper holder 217 is closed in the direction approaching the paper cover 214 (rightward in FIG. 12).

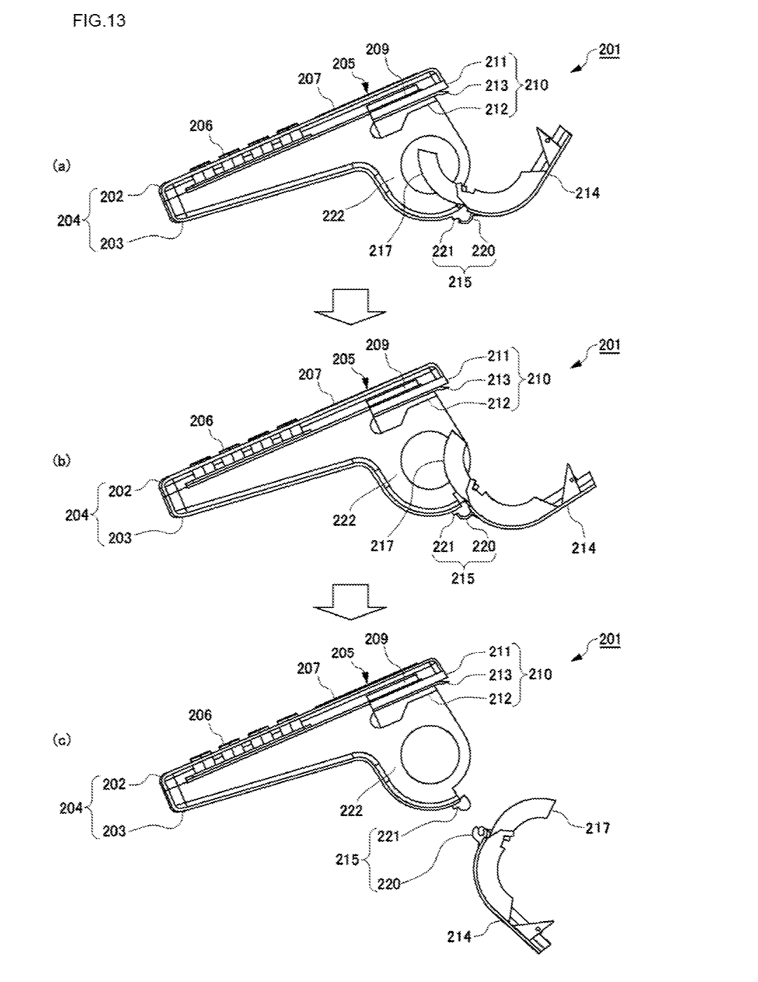

As shown in FIG. 13(a), the recording paper roll 216 is normally mounted and dismounted with the paper cover 214 opened to a normal opening position, but when the large recording paper roll 216 is mounted or dismounted, as shown in FIG. 13(b), the paper cover 214 is opened to a maximum opening position. At the maximum opening position, the leading end of an arc-like engaging piece 220 of the cover hinge 215 contacts a contact surface of an engaged part 221. As shown in FIG. 13(c), when the paper cover 214 is further opened from the maximum opening position, the cover hinge 215 is rotated with the leading end of the engaging piece 220 as the pivot point, and the engagement between the engaging piece 220 and the engaged part 221 of the cover hinge 215 is released. Once the cover hinges 215 are disengaged in this way, the paper cover 214 is detached from the casing 204. At this point, since the paper holder 217 is coupled with the paper cover 214, the paper holder 217 is detached from the casing 204 together with the paper cover 214.

According to such a terminal unit with a printer 201 in the embodiment of the present invention, the terminal unit can be made compact in the longitudinal direction, and moreover, the recording paper roll 216 can be easily mounted and dismounted.

More specifically, in this embodiment, the printer unit 210 and the recording paper roll 216 are disposed inside the casing 204 at the positions corresponding to the display part 205 on the surface (the same position as the display part 205 in planar view). Thus, by disposing the printer unit 210 (and the recording paper roll 216) at the position corresponding to the display part 205 (the same position in planar view), the longitudinal size (size in the upper-lower direction) of the terminal unit can be made smaller compared with the case where the printer unit 210 is disposed at the upper part of the display part 205 (upper end of the casing 204). In addition, in this case, the recording paper roll 216 can be easily mounted and dismounted by opening the paper cover 214 of the printer unit 210.

In this embodiment, since the paper holder 217 is coupled with the paper cover 214, as shown in FIG. 8, when the paper cover 214 is opened, the paper holder 217 is opened together with the paper cover 214, and the recording paper roll 216 held by the paper holder 217 is also pushed out of the recording paper roll housing part 222 toward the side to which the paper cover 214 is opened. Thus, the recording paper roll 216 can be easily dismounted, as fingers can be easily inserted into both ends of the roll paper and there is no need for worrying about the cutter 213.

In this embodiment, as shown in FIG. 9, the paper holder 217 can be opened in the direction away from the paper cover 214, in a state where the paper holder 217 is opened together with the paper cover 214. By opening the paper holder 217 in the direction away from the paper cover 214, opening between the paper holder 217 and the paper cover 214 is enlarged, so that even the large recording paper roll 216 can be easily mounted and dismounted.

As shown in FIG. 10, when the paper holder 217 is opened together with the paper cover 214, the position of the center of gravity of the paper holder 217 is offset on the paper holder 217 side from the position of the holder hinges 218. Thus, for example, when the paper cover 214 is opened in a state where the recording paper roll 216 is not held by the paper holder 217, the paper holder 217 is opened together with the paper cover 214, and then, the paper holder 217 opens due to its own weight (automatically) in the direction away from the paper cover 214. Thus, there is no need to manually open the paper holder 217, which facilitates the mounting work of the recording paper roll 216.

As shown in FIG. 13, when the paper cover 214 is further opened from the maximum opening position, the cover hinges 215 are disengaged, and the paper cover 214 and the paper holder 217 are detached from the casing 204. Thus, it is possible to prevent a situation where an excessive load is applied to the cover hinges 215 and the cover hinges 215 and the surrounding areas are damaged.

In this embodiment, the recording paper roll 216 held by the paper holder 217 is visible through the window part 219 on the side of the casing 204, and the remaining amount of the recording paper roll 216, etc. can be easily checked. In this case, since the holder hinges 218 are disposed at the positions where the holder hinges are invisible through the window part 219, the appearance of the terminal unit can be prevented from being impaired due to the holder hinges 218 being visible through the window part 219.

While the embodiments of the present invention have been described above by way of example, the scope of the present invention is not limited thereto and changes and modifications according to the purpose can be made within the scope described in the claims.

Besides the case where the terminal unit with a printer of the present invention is installed at distribution centers of delivery services, the terminal unit can of course also be used at retail stores, supermarkets, restaurants, etc.

While the preferred embodiments of the present invention that are conceivable at present have been described above, it is understood that various modifications can be made to the embodiments, and it is intended that all such modifications within the true spirit and scope of the present invention are included in the accompanying claims.

### INDUSTRIAL APPLICABILITY

As described above, the terminal unit with a printer according to the present invention has an advantage that the terminal unit can be made compact in the longitudinal direction, and it is useful, for example, as a transaction terminal unit, etc. to be installed at distribution centers of delivery services.

### REFERENCE SIGNS LIST

111 Terminal unit with a printer
112 Upper case
113 Lower case
114 Casing
115 Display part
116 Operation part
118 Recording paper roll housing part
120 Printer head
121 Paper sensor
122 Cutter
123 Recording paper
124 Paper ejection port
125 Platen roller
126 Recording paper roll
130 Paper cover
134 First guiding part
135 Second guiding part
201 Terminal unit with a printer
202 Upper case
203 Lower case
204 Casing
205 Display part
206 Operation part
207 Panel
208 Printed circuit board
209 Liquid crystal unit
210 Printer unit
211 Printer chassis
212 Printer head
213 Cutter
214 Paper cover
215 Cover hinge
216 Recording paper roll
217 Paper holder
218 Holder hinge
219 Window part
220 Engaging piece
221 Engaged part
222 Recording paper roll housing part

1. A terminal unit comprising:
a casing having a display surface with a display part disposed thereon;
a printer head provided inside the casing so as to face the display surface and adapted to print on recording paper pulled out of a recording paper roll; and
a recording paper roll housing part provided, on the side opposite to the display surface across the printer head, so as to face the printer head.

2. The terminal unit according to claim 1, wherein the display surface, a surface of the printer head facing the display surface, and an imaginary central axis of the recording paper roll are parallel to each other.

3. The terminal unit according to claim 1, wherein the printer head and the recording paper roll housing part are provided eccentrically on one end side of the casing.

4. The terminal unit according to claim 1, wherein
the casing further comprises a paper cover attached through cover hinge parts such that the paper cover can be opened and closed for mounting or dismounting of the recording paper roll,
the paper cover constitutes a part of the recording paper roll housing part and holds the recording paper roll, and
the cover hinge parts are provided on the side opposite to the printer head across the recording paper roll housing part.

5. The terminal unit according to claim 4, further comprising a paper holder which constitutes a part of the recording paper roll housing part and holds the recording paper roll inside the casing, wherein
the paper holder is attached to the paper cover such that, when the paper cover is opened, the paper holder is opened around holder hinges, which are disposed at an end of the side where the cover hinge parts are located, in the direction away from the paper cover.

6. The terminal unit according to claim 1, further comprising:
a paper ejection port for ejecting recording paper, which is pulled out of the recording paper roll, from the housing part; and
a cutter for cutting the recording paper which is pulled out, wherein
the cutter is disposed inside the casing between the printer head and the paper ejection port on the side of the display surface.

7. The terminal unit according to claim 6, wherein the paper cover constitutes a part of the paper ejection port at an end of the side opposite to the cover hinge parts.

8. The terminal unit according to claim 6, wherein a pair of first guiding parts, which are provided at an interval almost equal to a width of the recording paper roll at an end opposite to the cover hinge parts of the paper cover, constitute a part of the paper ejection port.

9. The terminal unit according to claim 6, further comprising a sensor which detects the recording paper pulled out of the recording paper roll and ejected from the housing part to the paper ejection port, wherein
the paper cover is provided with a second guiding part which is positioned at an end opposite to the cover hinge parts, on the side opposite to the sensor across an ejection path of the recording paper, so as to be face-to-face with the sensor.

10. The terminal unit according to claim 1, wherein
the casing further comprises: a paper cover attached through cover hinge parts such that the paper cover can be opened and closed for mounting or dismounting of the recording paper roll; and a paper ejection port for ejecting recording paper, which is pulled out of the recording paper roll, from the housing part, wherein
the paper cover constitutes a part of each of the recording paper roll housing part and the paper ejection port, and
the cover hinge parts are disposed at an end opposite to an end where the paper cover constitutes a part of the paper ejection port.

11. The terminal unit according to claim 10, further comprising a paper holder which constitutes a part of the recording paper roll housing part and holds the recording paper roll inside the casing, wherein
the paper holder is attached to the paper cover such that, when the paper cover is opened, the paper holder is opened around holder hinges, which are disposed at an end of a side where the cover hinge parts are located, in the direction away from the paper cover.

12. The terminal unit according to claim 10, further comprising a cutter for cutting the recording paper which is pulled out, wherein
the cutter is disposed inside the casing between the printer head and the paper ejection port on the side of the display surface.

13. The terminal unit according to claim 12, wherein a pair of first guiding parts provided at an interval almost equal to a width of the recording paper roll constitute a part of the paper ejection port.

14. The terminal unit according to claim 12, further comprising a sensor which detects the recording paper pulled out of the recording paper roll and ejected from the housing part to the paper ejection port, wherein
the paper cover is provided with a second guiding part which is positioned on the side opposite to the sensor so as to be face-to-face with the sensor across an ejection path of the recording paper.

15. The terminal unit according to claim 1, wherein
the casing further comprises: a paper ejection port for ejecting recording paper, which is pulled out of the recording paper roll, from the housing part; and a window part for viewing the recording paper roll in the housing part, and
the window part is provided on a surface of the casing which intersects both of a paper ejection surface, where the paper ejection port is provided, and the display surface.
